(19) United States
(12) Patent Application Publication
(10) Pub. No.: US 2018/0286435 A1
(43) Pub. Date: Oct. 4, 2018

(54) HEADSHELL AND TONEARM FOR MOUNTING CARTRIDGE OF AUDIO TURNTABLE AND AUDIO TURNTABLE COMPRISING SAME

(71) Applicant: Dong-Chan SON, Paju-si (KR)

(72) Inventor: Dong-Chan SON, Paju-si (KR)

(21) Appl. No.: 15/763,908

(22) PCT Filed: Sep. 21, 2016
(86) PCT No.: PCT/KR2016/010496

§ 371 Date: Mar. 28, 2018

(30) Foreign Application Priority Data
Sep. 30, 2015 (KR) 10-2015-0137217

(51) Int. Cl. G11B 3/38

(52) U.S. Cl. CPC G11B 3/38

(57) ABSTRACT

The present invention relates to a headshell and a tonearm, which are parts of an audio turntable, and, more particularly, to a headshell and a tonearm configured such that, in connection with a swingarm-type audio turntable, the groove of an LP record can be accurately read. According to an embodiment, in connection with a headshell that connects a cartridge and a tonearm, there is provided a headshell and a tonearm for mounting a cartridge of an audio turntable, comprising a joint portion that enables the cartridge, which has been coupled, to rotate on a horizontal plane.

### CROSS-REFERENCE TO RELATED APPLICATIONS

This patent application is a national-stage application of International Patent Application No. PCT/KR2016/010496, filed on Sep. 21, 2016, which claims priority under 35 U.S.C. § 119 to Korean Patent Application No. 10-2015-0137217, filed on Sep. 30, 2015, in the Korean Intellectual Property Office, the disclosure of which is incorporated by reference herein in its entirety.

### TECHNICAL FIELD

The present invention relates to headshells and tonearms, parts of audio turntables, and particularly, to headshells and tonearms of swing arm-type audio turntables, which enable accurate reading of the groove of an LP record.

### DISCUSSION OF RELATED ART

FIG. 1 is a view briefly illustrating a swing-type audio turntable in wide use. A needle of a cartridge 20 is guided along spiral grooves 31 and 32 formed in a record 30, reading out the sound source while gradually moving to the center of the record 30. At this time, a tonearm 10 swings around the shaft connected to the turntable.

In the figure, dashed lines denote the trajectory K along which the needle of the cartridge 20 travels as the tonearm 10 swings. The trajectory K has an overhang (the interval between the spindle S and the needle) from the center of the turntable. The overhang is intended to reduce an error angle that occurs as the needle moves inwards.

As the needle of the cartridge 20 moves along the arched trajectory K formed by the tonearm 10 swinging, the needle of the cartridge 20 may fail to be aligned with the direction of the tangent to all the grooves which are substantially circular.

Specifically, FIG. 1 illustrates the case where the turntable has been set such that the direction Di of the needle of the cartridge 20—the front-rear direction of the cartridge—is consistent with the direction of the tangent V1 to a first groove 31 which is larger in radius.

Where the tonearm 10 swings over time so that the needle of the cartridge 20 moves up to a second groove 32 having a smaller radius than the first groove 31, an angle A arises between the direction of the tangent V2 to the second groove 32 and the direction D2 in which the cartridge 20 is placed, meaning that the needle is slanted from the direction of the tangent to the groove 32, resulting in the needle's failure to precisely reading out information from the grooves and hence a disparity in played sound between the grooves 31 and 32 despite the fact that same sound source has been recorded in the grooves.

Furthermore, the needle contacting the groove while being inclined at the angle may cause one-side wear to the needle, damage to the LP record, and significant noises.

### SUMMARY

The present invention aims to address the above problems of existing audio turntables. Specifically, the present invention is intended to allow the cartridge needle to track along the direction of the tangent to the groove which is formed in the record and is nearly circular.

Other objectives of the present invention will be apparent to one of ordinary skill in the art from the detailed description set forth below.

To achieve the above objectives, according to an embodiment of the present invention, there is proposed a headshell for mounting a cartridge of an audio turntable, wherein the headshell connects the cartridge with a tonearm and has a joint part to enable the coupled cartridge to rotate on a horizontal plane.

As an example, the joint part may include a first part coupled with the cartridge and a second part connected with the tonearm, wherein the first part and the second part may be jointed together via a bearing.

As per another embodiment, the joint part may include a first part and a second part jointed together, the first part coupled with the cartridge and the second part connected with the tonearm. The second part may include springs provided at a left side and a right side of the joint part and elastically pushing the first part against the second part and tension adjustors each adjusting tension of a respective one of the springs.

According to another embodiment, there is proposed a tonearm provided in an audio turntable, able to swing, and having a cartridge mounted on a front tip thereof, wherein the tonearm includes a joint part to enable a cartridge coupled to rotate on a horizontal plane.

An embodiment of the present invention may deliver an enhanced sound quality upon playing records. In particular, the present invention may diminish a disparity in sound quality when the record is played along its outer and inner grooves, along with one-sided wear of the needle and damage to the record and noise.

Other effects of the present invention may be apparent to one of ordinary skill in the art from the detailed description set forth below or practicing the present invention.

### BRIEF DESCRIPTION OF THE DRAWINGS

FIG. 1 is a view briefly illustrating an audio turntable according to the prior art;

FIG. 2 is a perspective view illustrating a headshell according to an embodiment of the present invention;

FIG. 3 is an exploded perspective view illustrating the embodiment of FIG. 2;

FIG. 4 is a side cross-sectional view of the embodiment of FIG. 2;

FIG. 5 is a bottom perspective view of the embodiment of FIG. 2;

FIG. 6 is a bottom view illustrating a state of use of the embodiment of FIG. 2;

FIG. 7 is a view briefly illustrating a state of use of an audio turntable to which the embodiment of FIG. 2 applies;

FIG. 8 is an exploded perspective view illustrating a headshell partially disassembled according to another embodiment of the present invention;

FIG. 9 is a bottom view of the embodiment of FIG. 8; and

FIG. 10 is a perspective view briefly illustrating a state of use of a tonearm according to an embodiment of the present invention.

### DETAILED DESCRIPTION OF EXEMPLARY EMBODIMENTS

Hereinafter, according to the present invention, configurations, functions, and operations of a cartridge-mountable headshell and tonearm and an audio turntable including the headshell and the tonearm are described with reference to the accompanying drawings. The same reference numbers refer to the same or similar elements throughout the drawings and the specification.

The terms “first” and “second” as used herein are used, for convenience, to distinguish between components that have the same or similar meaning. That is, some component may arbitrarily be termed a “first component” or “second component.”

The accompanying drawings show embodiments of the present invention, but the technical spirit of the present invention should not be intended as limited thereby. The whole or part shown in the drawings does not limit the invention defined in the claims if it can be construed from a point of view of one of ordinary skill in the art that its shape, form, or order is inevitable in practicing the present invention.

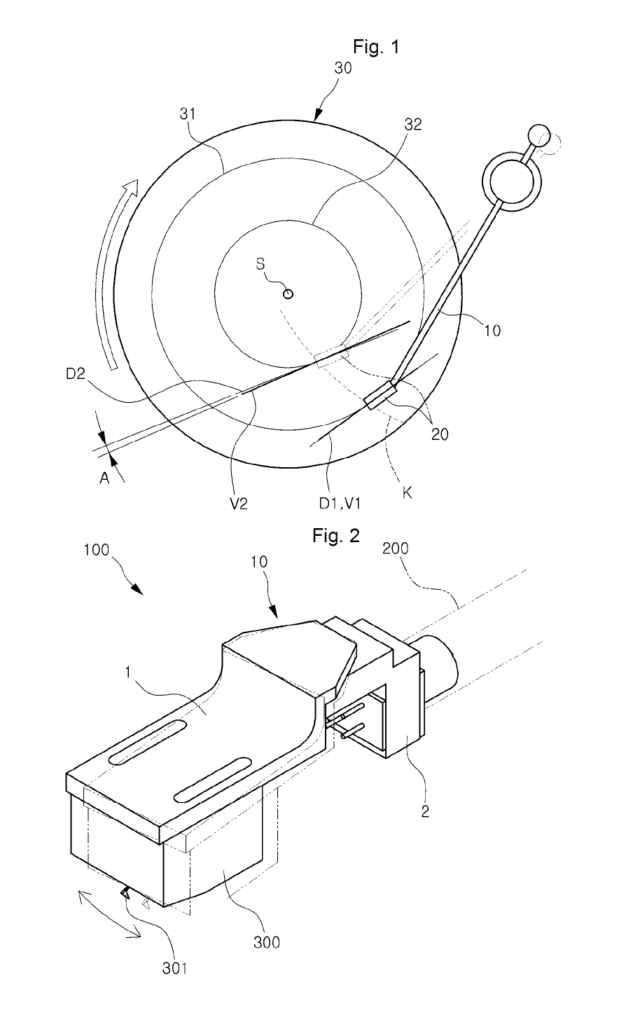

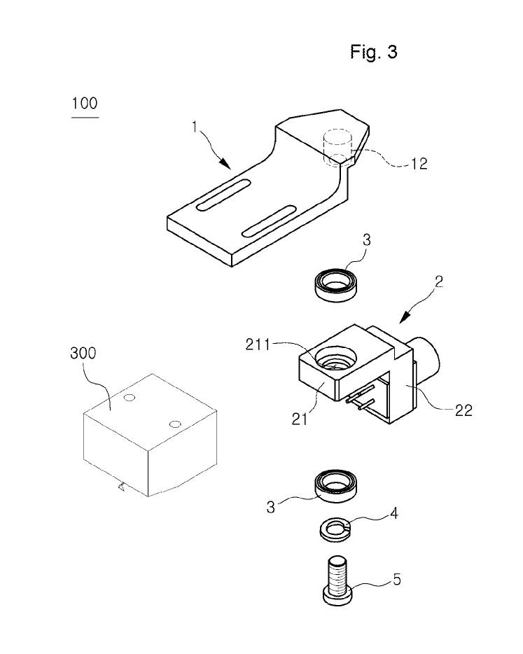

FIGS. 2 to 7 relate to a cartridge-mountable headshell of an audio turntable according to the present invention.

A headshell 100 is a member connecting a cartridge 300 with a tonearm. The cartridge 300 attached to the headshell 100 may be gradually relocated by adjusting the bolt according to the known art. Although not specifically shown, the headshell according to the present invention may take a configuration or shape for changing the location where the cartridge is affixed according to the conventional art.

The headshell 100 includes a joint part 10 that enable the cartridge 300 to rotate on the horizontal plane with the tonearm fastened.

To that end, specifically, the headshell 100 includes a first part 1 to which the cartridge 300 is fastened and a second part 2 coupled to the tonearm 200. The first part 1 and the second part 2 are jointed together, forming the joint part 10.

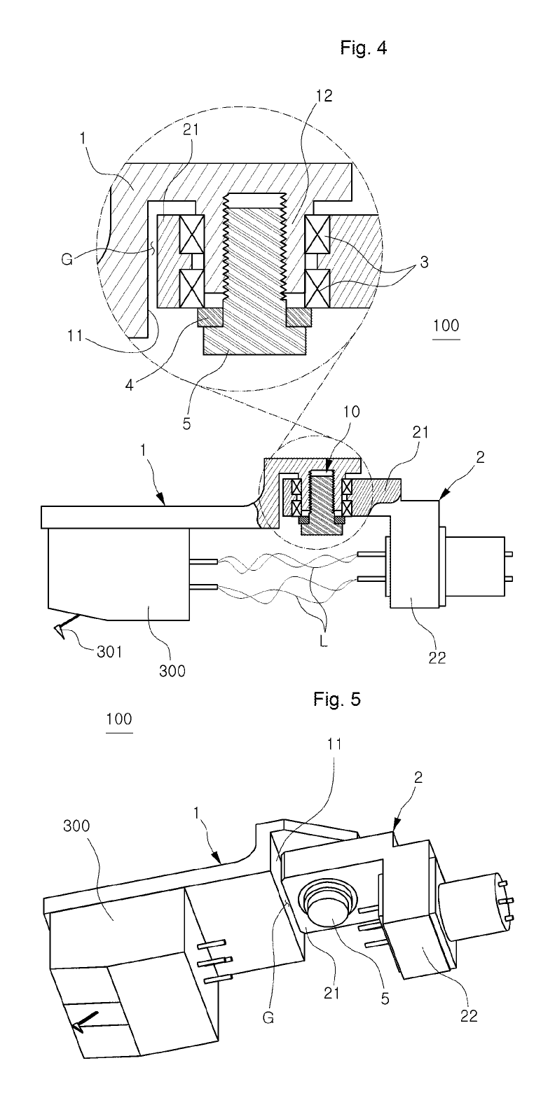

The cartridge 300 is detachably affixed onto the bottom of a front tip of the first part 1, and a rear tip of the first part 1 is stepped from the front tip. Referring to FIGS. 4 and 5, a vertical wall surface 11 is formed rearwards due to a difference in height between the front tip and the rear tip.

The rear tip of the first part 1 has a joint shaft 12 which is shaped as a cylinder extends downwards. A screw hole is formed in the joint shaft 12, allowing a bolt 5 to be fitted therein.

The second part 2 includes a front tip block 21 and a rear tip block 22. A mounting hole 211 is formed in the front end block 21 to joint with the first part 1. The rear tip block 22 extends from the front tip block 21 and connects with the tonearm 200. A bearing 3 is mounted in each of the top and bottom of the mounting hole 211. The joint shaft 12 is fitted into the mounting hole 211, with the bearings 3 mounted. The bolt 5 is fitted into the screw hole of the joint shaft 12 with a spring washer 4 placed, thereby completing the assembly of the joint part 10.

Referring to FIG. 4, at the side view of the headshell 100 assembled, the joint part 10 is formed in an upper portion of the middle of the assembled headshell 100. Thus, a space may be secured for connecting lead lines L to the rear tip block 22 of the second part 2 and the cartridge 300. Output terminals of the cartridge 300 and input terminals of the rear tip block 22 are connected to the lead lines L which are bendable. Given the rotation of the cartridge 300, the lead lines L are loosely connected to the terminals.

As such, as the first part 1 and the second part 2 are jointed to each other, the first part 1 provided with the cartridge 300 may freely turn on the horizontal plane.

Although not shown, various changes may be made to the joint part. The first part and the second part may adopt various pivot connections or magnetic joints to allow the first part to rotate about the second part on the horizontal plane.

Further, the angle at which the first part 1 turns about the second part 2 may be limited to a range. At this time, such configuration is possible as to limit the angle of rotation of the first part 1 while bringing the second part 2 in contact with the first part 1.

In the embodiment of FIGS. 1 to 7, the range of angles at which the first part 1 is rotatable may be limited by the contact between the vertical wall surface 11 formed in the middle of the first part 1 and the front tip of the front tip block 21 of the second part 2.

Referring to FIGS. 4 to 6, in the state of assembly where the first part 1 and the second part 2 are aligned on a straight line—e.g., the state where the angle of rotation of the first part with respect to the second part is 0 degrees—a gap G is formed between the vertical wall surface 11 of the first part 1 and the front tip of the front tip block 21 of the second part 2.

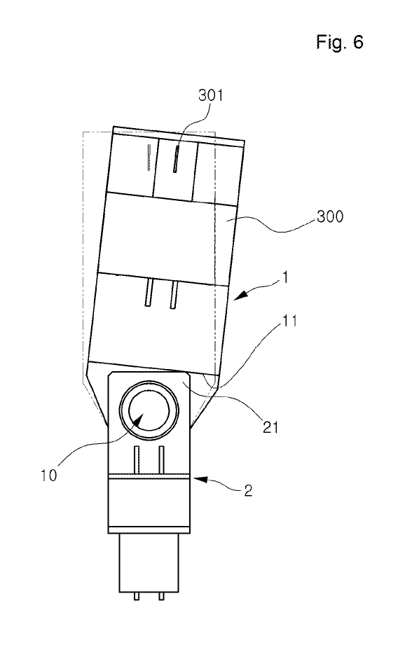

In FIG. 6, as the first part 1 rotates clockwise, a right-hand edge of the front end block 21 comes in contact with the vertical wall surface 11 of the first part 1, thereby restricting the rotation of the first part 1.

The front tip block 21 of the second part 2 has left-hand and right-hand edges chamfered. Chamfering the edges in different sizes or changing the interval of the gap G between the vertical wall surface 11 and the front tip block 21 enables designing different ranges for the maximum angle at which the first part 1 may rotate about the second part 2.

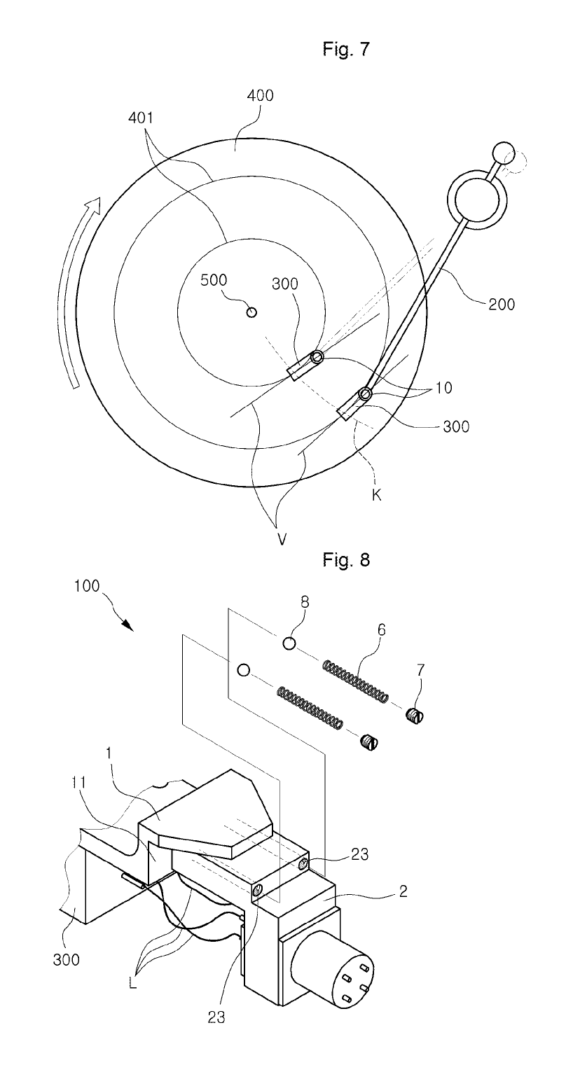

FIG. 7 concerns the movement of the cartridge 300 placed on a record 400.

Using the tonearm 200 swinging, the trajectory K of the needle of the cartridge 300 to read the groove 401 of the record 400 forms an arch, and such trajectory K may be the same as the trajectory of the needle according to the prior art shown in FIG. 1.

According to an embodiment of the present invention, the headshell includes the joint part 10, which enables the needle of the cartridge 300 to follow the direction of tangent to the groove, which nearly forms a circle, by the force of the needle being pulled by the groove 401.

Further, where the cartridge 300 moves close to the spindle 500 as per playing music so that the needle runs on the groove 401 which is a smaller circle, the first part may be turned by the force of being pulled by the groove 401, allowing the needle of the cartridge 300 to be positioned close to the direction of the tangent V of the groove 401.

As such, while the record plays, the needle may naturally be placed in the direction of the tangent V to the whole groove 401, thereby able to precisely read sound without being pushed to either the left or right of the groove. This delivers a constant sound quality on the inner groove or outer groove of the record, i.e., regardless of the position of the groove, leading to an overall sharply enhanced sound quality.

Further, the needle may always pass midway of the groove, greatly reducing its one-sided wear and resultant wear or damage to the record groove and noise.

Specifically, the record groove which is formed of plastic tends to be subject to out-of-roundness worsening due to a fabrication tolerance or deformation. In conventional turntables, thus, the cartridge needle cannot pass between both walls of the groove under even forces. By contrast, in the headshell as per an embodiment of the present invention, the first part may adequately be rotated through the joint part along the direction of the force of the needle is stuck and pulled to the groove, delivering superior sound quality even from records deformed.

Meanwhile, limiting the angular range in which the first part 1 may turn about the second part 2 may relieving the user of the inconvenience of placing the needle in exact position on the groove of the record 400 that would be caused by otherwise excessive turning of the first part 1. Further, the present invention allows the needle which is to be placed on the groove to comply with the direction of proceeding along the groove to some degree, preventing inconvenience upon initial loading and damage to the needle or groove that would occur as the needle is loaded off the groove.

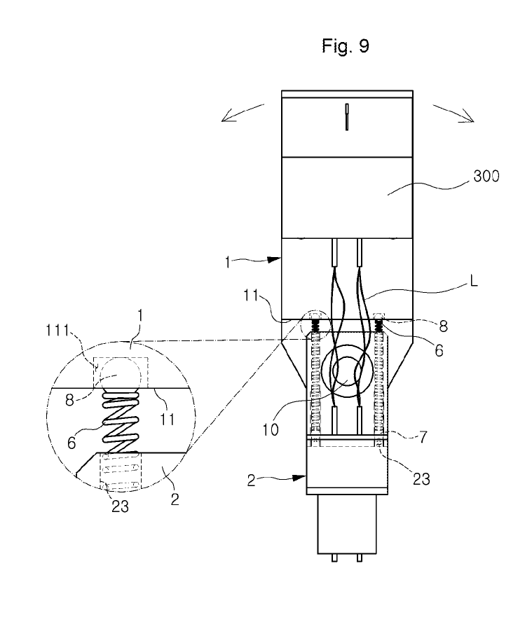

FIGS. 8 and 9 are directed to a cartridge-mountable headshell of an audio turntable according to another embodiment of the present invention.

According to another embodiment of the present invention, a headshell 100 includes a first part 1 and a second part 2 that are connected together via a joint part 10. The technical features of the first part 1, the second part 2, and the joint part 10 may encompass those of the embodiment shown in FIGS. 1 to 7 without conflicting with what has been described below.

In the embodiment shown in FIGS. 8 and 9, the headshell 100 includes springs 6 at left and right sides of the joint part 10 and tension adjusters 7 able to set different tensions to the springs 6.

Referring to FIG. 8, the second part 2 has a pair of through holes 23 which are left-right symmetrical with respect to the joint part 10. The first open ends of the through holes 23 face the vertical wall surface 11 of the first part 1. The inner surfaces of the through holes 23 may be treaded.

The springs 6 are fitted into their respective through holes 23. The springs 6 pass and are exposed through the first ends of the through holes 23, contacting the first part 1. The front ends of the springs 6 are directed to the vertical wall surface 11, with balls 8 provided between the vertical wall surface 11 and the front ends of the springs 6.

Referring to FIG. 9, trenches 111 are formed in the vertical wall surface 11 to partially receive the balls 8. The bottoms of the trenches 111 are flat and come in point contact with the balls 8. When the first part 1 rotates about the second part, the positions where the balls 8 contact the trenches 111 may be varied depending on the angle at which the springs are twisted.

As such, the point contact made between the balls 8 and the first part 1 may reduce external vibration delivered to the first part 1.

Although not shown, according to another embodiment, the balls and the trenches in the vertical wall surface may be omitted, or the balls may be replaced with convex protrusions on the vertical wall surface. Alternatively, convex surfaces may be formed on the bottoms of the trenches, and cylindrical bodies to make point contact with the convex surfaces may be coupled to the front ends of the springs.

Each tension adjuster 7 is provided per spring 6, adjusting the length of the spring 6 to vary tension. In the embodiment shown, the tension adjusters 7 may be headless bolts that may be screwed into the through holes 23 and be adjustable for depth of insertion. The headless bolts may be rotated by a tool such as a screwdriver and are moved back and forth in the through holes 23 along the direction of rotation. The headless bolts may support the ends of the springs 6, and as the headless bolts move forwards or rewards, the springs 6 may be compressed or released, changing their tension.

Although not shown, the tension adjusters 7 may be replaced with various spring supporting means capable of changing position to adjust the length of the springs.

The first part 1 which is elastically supported by both springs 6 is placed substantially in straight line with the second part 2 in its normal position where no external force is exerted thereto. As such, since the tonearm, the headshell 100, and the cartridge 300 are substantially aligned along a straight line, the first part 1 and the cartridge 300 may remain in the straight position along the lengthwise direction of the tonearm when one lifts up the tonearm to put the cartridge on the record or when putting the tonearm back to its original position after the playback of music ends. Thus, user convenience is enhanced.

The springs 6 may reinforce the structural rigidity of the headshell 100 by elastically supporting the first part 1. An increased rigidity between the first part 1 and the second part 2 reduces the vibration of the first part 1 coupled with the cartridge 300, mitigating sound distortions.

The tension of each of the springs 6 provided at both sides of the joint part 10 affects the rotation of the first part 1 about the second part 2.

The left-hand and right-hand springs 6 elastically support the first part 1, suppressing the vibration of the cartridge and hence having an influence on reading the groove, resultantly a change in sound quality. Specifically, sound being played tends to be tightened when the springs are in high tension and richer in less tension. Accordingly, the user may change the tension of the springs 6 via the tension adjusters 7 to figure out sound quality to her preference.

The tension adjusters 7 each provided at a respective one of the left-hand and right-hand springs 6 allows the user to adjust the tension of the left-hand and right-hand springs to different degrees.

The tension of lead lines L connecting the cartridge 300 of the first part 1 with the second part 2 may disturb aligning the first part 1 with the second part 2. The tension adjusters 7 may be used for the purposes of aligning the first part 1 with the second part 2 as possible while canceling off the influence of the lead lines L.

Further, the tension adjusters 7 allows the user to put the cartridge 300 in alignment with the tonearm. This feature delivers convenience to novices who are unskillful at cartridge alignment.

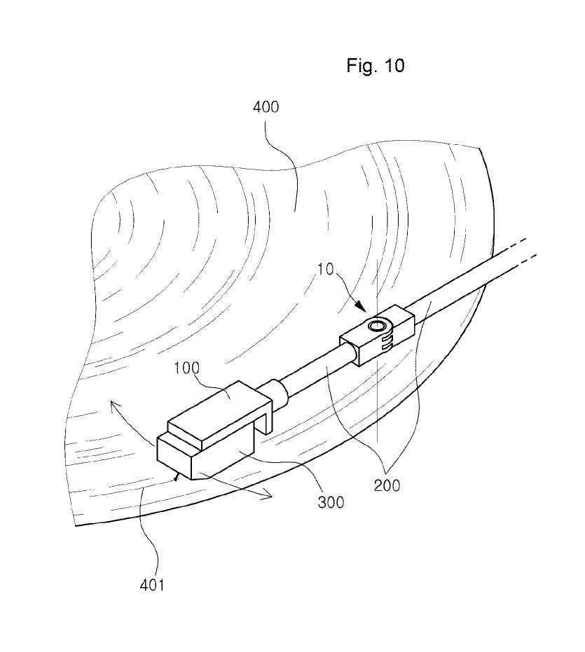

Meanwhile, FIG. 10 relates to a tonearm according to an embodiment of the present invention.

According to an embodiment of the present invention, a tonearm 200 is provided in an audio turntable and is of a swing type. A cartridge 300 is mounted on a front tip of the tonearm 200, and as shown, the cartridge 300 may be fastened through a headshell 100 affixed to the front tip of the tonearm. Here, the headshell 100 is a conventional one with no rotating feature. In this case, the headshell 100, the cartridge 300, and the front tip of the tonearm 200 where the headshell is joined may be considered as being integrally formed.

The tonearm 200 has a joint part 10 that allows the cartridge 300 to turn over a horizontal plane. In the embodiment shown, the joint part 10 divides the tonearm 200 into two parts and joints the two parts. Although not shown, the joint part may be replaced with other various connections, e.g., a pivot connection, like the headshell in the above-described embodiment.

In the tonearm 200 having the joint part 10, its front tip with the cartridge 300 is rotatable, allowing the needle 301 pulled to the groove 401 of the record 400 to be aligned in the direction of tangent to the groove 401. Accordingly, as set forth above, the needle may accurately read out information from the groove without being pushed to any side of the groove.

The above-described joint part-equipped headshell or tonearm may be mounted on an audio turntable, whether conventional or not, in such a manner as to remove and replace corresponding parts.

Further, the headshell with the joint part is also applicable to liner tracking arm-type turntables, but not only to swing types. According to an embodiment of the present invention, where the headshell is mounted on a tracking arm, although the groove is misaligned in center with the record, the cartridge may properly rotate along the trajectory of the groove, allowing for reading evenly from both sides of the groove.

According to embodiments of the present invention, use of the headshell and tonearm may relieve novices of difficulty in setting the audio turntable while delivering satisfactory record playing capability to experts.

1. A headshell for mounting a cartridge of an audio turntable, the headshell connecting the cartridge with a tonearm, wherein the headshell includes a joint part enabling the cartridge coupled to rotate on a horizontal plate, and wherein such rotation is made by the joint part that a needle of the cartridge is aligned in direction with a tangent to a groove of a record by a force of the needle of the cartridge being pulled along the groove.

2. The headshell of claim 1, wherein the joint part includes a first part and a second part jointed together via a bearing, the first part coupled with the cartridge and the second part connected with the tonearm.

3. The headshell of claim 1, wherein the joint part includes a first part and a second part jointed together, the first part coupled with the cartridge and the second part connected with the tonearm, and wherein the second part includes springs provided at a left side and a right side of the joint part and elastically pushing the first part against the second part and tension adjustors each adjusting tension of a respective one of the springs.

4. A tonearm provided in an audio turntable, able to swing, and having a cartridge mounted on a front tip thereof, wherein the tonearm includes a joint part to enable a cartridge coupled to rotate on a horizontal plane.

5. An audio turntable having a headshell, the headsell configured to mount a cartridge of an audio turntable, the headshell connecting the cartridge with a tonearm, wherein the headshell includes a joint part enabling the cartridge coupled to rotate on a horizontal plate, and wherein such rotation is made by the joint part that a needle of the cartridge is aligned in direction with a tangent to a groove of a record by a force of the needle of the cartridge being pulled along the groove.
